(19) United States
(12) Patent Application Publication
(10) Pub. No.: US 2021/0245712 A1
(43) Pub. Date: Aug. 12, 2021

(54) AUTOMOTIVE SECURITY SYSTEM AND A METHOD OF USE THEREOF

(71) Applicants: Joseph Jay Jeffers, JR., Miami, FL (US); James Lewis Robinson, JR., Miami, FL (US)

(72) Inventors: Joseph Jay Jeffers, JR., Miami, FL (US); James Lewis Robinson, JR., Miami, FL (US)

(21) Appl. No.: 17/243,400

(22) Filed: Apr. 28, 2021

(51) Int. Cl. B60R 25/30; B60R 25/31; B60R 21/0136

(52) U.S. Cl. CPC B60R 25/305; B60R 25/302; B60R 2021/01013; B60R 21/0136; B60R 2300/8073; B60R 25/31

(57) ABSTRACT

An automotive imaging security system for a vehicle for recording an immediate environment of the vehicle upon an occurrence of a predetermined event. The automotive imaging security system includes four cameras coupled at the four corners of the vehicle's body and configured to capture the immediate environment of the vehicle. The automotive imaging security system further includes one or more sensors configured to detect the predetermined event and activate the camera.

### FIELD OF INVENTION

The present invention relates to a security system for a vehicle and a method of use thereof, and more particularly the present invention relates to an automotive imaging securing system for capturing an immediate environment of the automobile upon the occurrence of a predetermined event.

### BACKGROUND

Prior art is rich in security systems for vehicles that provide protection against theft. The known security systems are based on different technical advancements including a better locking system, biometric access to the vehicle, tracking of the vehicle through a remote app, remote stalling of the vehicle, and like events. Additionally, known are security systems that can notify thefts and intrusions in the vehicle.

However, the vehicles may not only be secure against theft but also damage. Incidents of intension and unintentional damage to the vehicles are on the rise. For example, someone may hit a parked vehicle and drive off. It is very difficult to track or identify the miscreant driver or the vehicle. Also, accidents may happen on the road while driving. Besides someone may, for whatsoever reason, intentionally damage a vehicle and flee.

Thus, a long-term desire is there for an automotive security system that can help to identify a miscreant that damaged a vehicle.

### SUMMARY OF THE INVENTION

The following presents a simplified summary of one or more embodiments of the present invention in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to an automotive imaging security system that can help in identifying a miscreant that damaged a vehicle.

It is another object of the present invention that the system can notify an owner of the vehicle about a predetermined event.

It is still another object of the present invention that the system can notify an owner of the vehicle in case of vehicle damage.

It is yet another object of the present invention that the system can provide evidence against a miscreant for vehicle damage or theft.

It is a further object of the present invention that the system can provide a near-real-time video feed of the vehicle damaged or being damage.

In one aspect, disclosed is an automotive imaging security system for vehicles having at least two cameras coupled to the vehicle's body and configured to capture an immediate environment of the vehicle. The automotive imaging security system further comprises one or more sensors configured to activate the camera upon detecting a predetermined event.

In one aspect, the predetermined event is impacting on the vehicle having the disclosed system. The impact may be on an external body of the vehicle and include forceful intrusion in the vehicle or theft.

In one aspect, the predetermined event can be the presence of a key fob within a predefined range from the vehicle but outside the vehicle.

In one aspect, the disclosed system includes a control unit operably coupled to the cameras and the sensors. The control unit including network circuitry for communicating with one or more remote devices or a server including a cloud server.

In one aspect, the control unit can transmit a near-real-time video feed of the cameras to the remote device or the server, wherein the near-time video feed can be recorded on the user device or the server. The near-time video feed can also be viewed on the user device.

In one aspect, the disclosed control unit of the system can send notifications to the remote device on sensing the predetermined event.

In one aspect, the system can also include an alarm operably coupled to the control unit. The control unit on detecting the damage, forceful intrusion, or theft of the vehicle can trigger the alarm.

In one aspect, the disclosed control unit of the system can receive commands from the remote device, such as turning the alarm off.

These and other objects and advantages of the embodiments herein and the summary will become readily apparent from the following detailed description taken in conjunction with the accompanying drawings

### BRIEF DESCRIPTION OF DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 shows the camera of the disclosed automotive imaging security system for a vehicle, according to an exemplary embodiment of the present.

FIG. 2 shows two cameras coupled just under the roof of a vehicle in front and rear sides, according to an exemplary embodiment of the present.

FIG. 3 shows the two cameras just coupled under the roof of the vehicle at the front left and front right sides, according to an exemplary embodiment of the present.

FIG. 4 shows the field of view of the four cameras coupled at four corners of the vehicle in the roof, two on the front side and two on the rear side, according to an exemplary embodiment of the present.

FIG. 5 shows a key fob having a key of the vehicle, according to an exemplary embodiment of the present.

FIG. 6 is an environmental diagram showing the disclosed system connected to a server and a user device, according to an exemplary embodiment of the present.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

Disclosed is an automotive imaging security system for vehicles that can record any activity in the immediate environment of the vehicle on the occurrence of a predetermined event. The immediate environment includes a space around the vehicle within a predefined distance range from the vehicle. For example, the space within 15-20 feet or 10-15 feet from the vehicle. The predetermined event can be an event related to the vehicle, which can be preconfigured in the disclosed system, and the occurrence of which activates the disclosed system. In one case, the predetermined event can be an impact on the outside of the vehicle at rest, for example hitting the parked vehicle by an object or another vehicle. In one aspect, the predetermined event can be forced intrusion in the vehicle. In one aspect, the predetermined event can be the forceful or unlawful unlocking of the vehicle for theft or other reasons. In one aspect, the predetermined event can be the presence of a key fob, having the keys of the vehicle, within the proximity of the vehicle. The proximity can be a predefined distance from the vehicle, such as within 15 feet, 10 feet, or 6 feet. One or more of the predetermined events can be pre-configured in the disclosed system. Additionally, an option can be provided to add a new predetermined event or remove an old one from the system. Moreover, the parameters of the predetermined event, such as distance from the vehicle can be modified at any time before and after installation of the disclosed system in the vehicle. An option can also be provided that allows the owner to choose between the preconfigured events in the disclosed system. The system can be installed in new vehicles as well as retrofitted in the old vehicles.

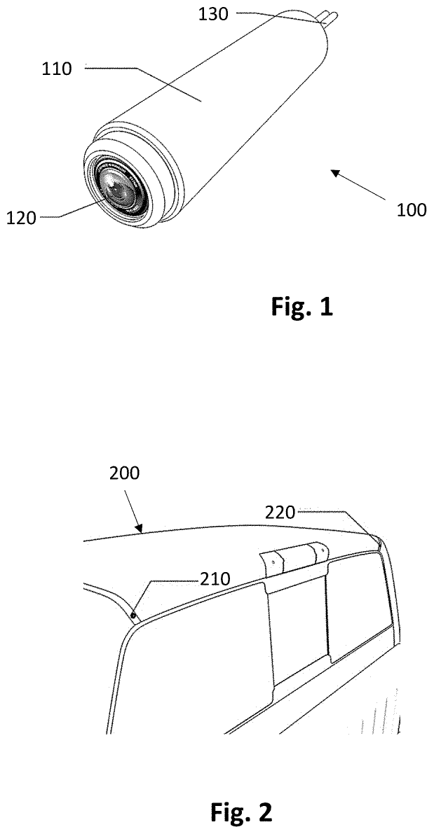

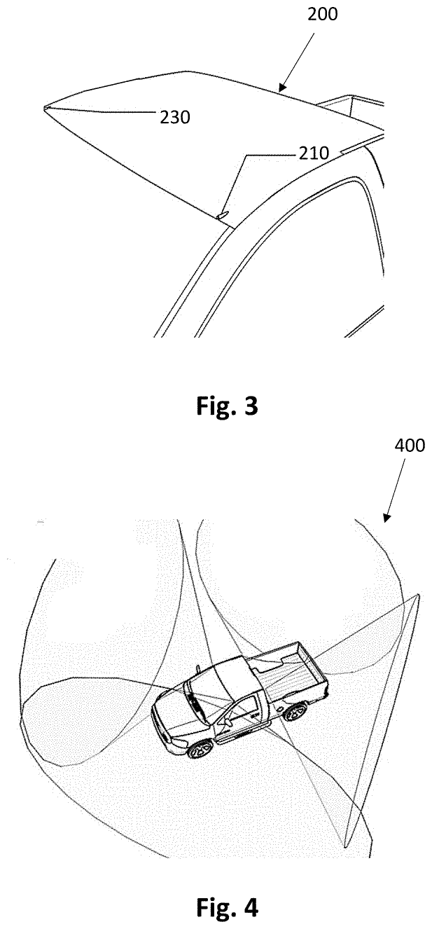

Referring to FIG. 1, which shows an exemplary embodiment of the camera 100 of the disclosed system. The system can include at least two digital cameras positioned on the vehicle such as to capture the immediate environment of the vehicle. For example, one camera can be installed at the front and another camera can be installed on the rear side of the vehicle. It is to be understood that more than two cameras are within the scope of the present invention. Preferably, four cameras can be used each at four corners of the vehicle. In one case, each of the four cameras can be positioned just below the roof of the vehicle. FIG. 2 shows the two cameras 210 and 220 installed just below the roof on the front and rear sides of vehicle 200. FIG. 3 shows the two cameras 210 and 230 installed just below the roof on the front left side and the front right side of vehicle 200. Similarly, a fourth camera can be placed at the remaining corner of the vehicle's roof. The four cameras can capture the immediate environment of the vehicle which is within the field of view of the camera. FIG. 4 shows the field of view 400 of the four cameras covering almost the entire immediate environment of the vehicle, or at least the 360° surrounding of the vehicle.

Referring to FIG. 1, camera 100 includes a hollow cylindrical housing 110 which encloses the components of the camera. The hollow housing can be rigid and durable to prevent any shock or tampering to the camera. Moreover, the housing can include fasteners or brackets for securely mounting the camera to the vehicle. FIG. 1 shows the cylindrical housing, however, the shape of the housing can vary without departing from the scope of the present invention. Additionally, the housing can be waterproof and dustproof to protect the enclosed components of the camera. The camera 100 includes lenses 120 which can have a wide view angle. The lenses can autofocus on an object to provide a clear image of the object. For example, the lenses can autofocus on the number plate of the vehicle, or face of a person, or a driver in the vehicle within field of view of the camera. The camera can be operably coupled to a control unit of the disclosed system. The control unit can control the focusing of the lenses to the desired object. Moreover, the position or angles of the lenses can be manually tweaked through a remote device. Camera 100 is also shown to have pins 130 for connecting the camera to the electrical system and the control unit of the system.

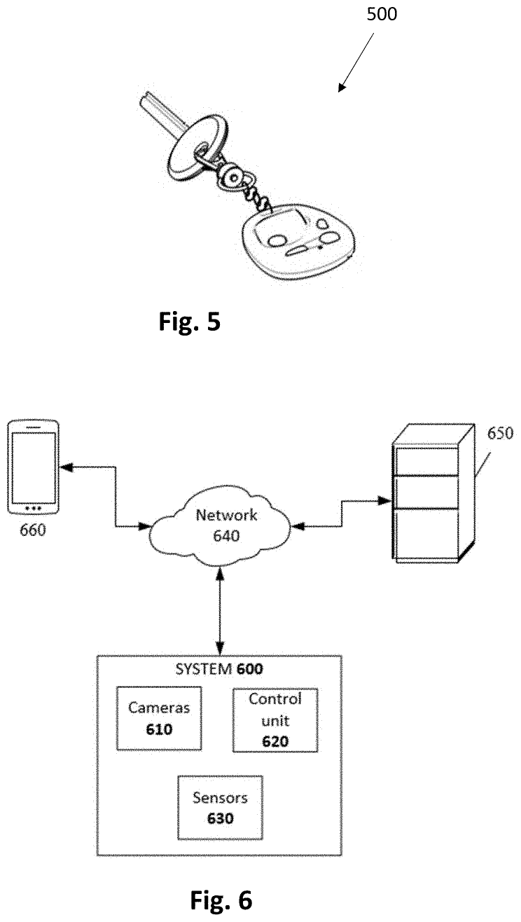

FIG. 6 shows the system 600 having cameras 610, control unit 620, sensors 630, wherein the cameras and the sensors are operably connected to the control unit. The system may also include the alarm system or connected to an alarm system of the vehicle. The system may also include a key fob 500, as shown in FIG. 5. The key fob 500 includes the keys of the vehicle. Moreover, the key fob can include other known functions of the key fob for a vehicle, such as locking and unlocking the vehicle. The sensors 630 can be installed in the vehicle such as to detect any impact on the exterior of the vehicle, such as hit by an object or another vehicle. The sensors on detecting the impact can send a signal to the control unit. The sensors can also sense forceful intrusion in the vehicle, for example by sensing the excessive force of the door. The sensor may also detect the forced or unlawful opening of the vehicle, for example, the insertion of any object other than the key into the lock of the vehicle can be detected by the sensors, and a signal indicating the same can be sent to the control unit. The sensor can be configured to detect different means known for stealing the vehicle. In a preferred embodiment, the sensors can also detect the disclosed key fob within the predefined range from the vehicle, for example within 15 feet, 10 feet, or 6 feet from the vehicle and outside the vehicle. The sensor upon detecting the key fob within the predefined range can send a signal to the control unit indicating the same.

The control unit upon receiving the signal from the sensor indicating any of the above events can activate the cameras to start recording the immediate environment of the vehicle. For example, on detecting the key fob within the pre-defined range of the vehicle, the control unit can start the cameras, wherein at least one of the cameras can focus on the person carrying the key fob. Although all the cameras may work and capture the complete vicinity of the vehicle. Similarly, in case the vehicle is hit by another vehicle, the control unit can activate the cameras to capture the car. Also, at least one camera can focus on the number plate and/or driver in the miscreant vehicle. Similarly, in the case of intrusion or forceful unlocking/breaking of the lock, the control unit can activate the cameras.

Referring to FIG. 6 which shows the disclosed system connected to a server 650 and one or more user devices 660. The system can connect with external devices or servers through a network 640. The control unit may include a network circuitry for connecting to an external network. For example, the network can be a wireless network including, but not limited to BLUETOOTH, Wi-Fi, Worldwide Interoperability for Microwave Access (WiMAX), an infrared channel, or satellite band. The wireless network may also include any cellular network, such as 2G, 3G, 4G, or 5G. The control unit can directly connect to the server and the user device or the user device can connect to the server already connected with the disclosed control unit.

The control unit can transmit the video feed from the camera, in near real-time, to the server and the user device. The server can be a cloud server, which can connect the control unit to the user device. The user device can be a computing system, such as smartphone, laptop, computer, desktop, workstation, tablet computer, smartwatch, and like devices. The user device can also be a standalone recorder for recording the video feed from the cameras. The recorder in one case can be installed in the vehicle itself or outside the vehicle. For example, the recorder can be installed at the home of the owner. Alternatively, the video feed can be recorded at the server or the cloud server, which can be accessed by the user device anytime. The access to the server can be secured, for example, the owner can be provided with a username and password for authenticating the user device to connect to the server for gaining access to the near real-time video feed or the recordings.

An interface can be provided on the user device which may include an admin panel to configure or modify the settings of the disclosed system. The interface may also allow viewing the near real-time video feed from the cameras. The interface may also allow connecting to the server or the recorder for accessing the live video or the recordings. Through the interface, a user may also modify the position of the lenses of the camera, such as to focus on an object. The interface on the user device can be provided as application software. In one case, the application software can be downloaded from an application distribution platform, such as App Store, Google Play, Chrome Webstore, and Amazon Appstore. Alternatively, the interface can also be provided through world-wide-web and accessible on the user's device through a web browser, such as Chrome.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. An automotive imaging security system comprising:
at least two cameras configured to be mounted in a vehicle for capturing an immediate environment of the vehicle;
one or more sensors configured to be installed in the vehicle and detect an occurrence of a predetermined event; and
a control unit operably coupled to the at least two camera and the one or more sensors, the control unit configured to:
receive a signal from the one or more sensors indicating the occurrence of the predetermined event,
upon receiving the signal, activate the at least two cameras;
upon activation of the camera, receiving a video feed from the at least two cameras, and
transmitting, the video feed to an external device through a network, wherein the control unit includes a network circuitry for connecting the network.

2. The automotive imaging security system according to claim 1, wherein the immediate environment is a space surrounding the vehicle within predefined distance.

3. The automotive imaging security system according to claim 2, wherein the predefined distance is 10-15 feet from the vehicle.

4. The automotive imaging security system according to claim 1, wherein the predetermined event is an external impact on the vehicle.

5. The automotive imaging security system according to claim 4, wherein the external impact is hitting the vehicle by another object or a vehicle.

6. The automotive imaging security system according to claim 1, wherein the predetermined event is an intrusion in the vehicle, forceful unlocking of the vehicle, or a combination thereof.

7. The automotive imaging security system according to claim 1, wherein the predetermined event is the presence of a key fob within a predefined distance from the vehicle but outside the vehicle, the key fob including the keys of the vehicles.

8. The automotive imaging security system according to claim 1, wherein the control unit is also configured to:
upon receiving the signal, sending a notification on the external device indicating the occurrence of the predetermined event.

9. The automotive imaging security system according to claim 1, wherein the control unit is also configured to:
upon activation of the camera, focusing at least one camera of the at least two cameras on an object in the immediate environment.

10. The automotive imaging security system according to claim 9, wherein the predetermined event is the presence of a key fob within a predefined distance from the vehicle but outside the vehicle, the key fob including the keys of the vehicles, wherein the object is a face of a person carrying the key fob.

11. The automotive imaging security system according to claim 9, wherein the predetermined event is hitting the vehicle by another vehicle, wherein the object is a number plate of the another vehicle or a driver of the another vehicle.

12. The automotive imaging security system according to claim 1, wherein automotive imaging security system includes four cameras configured to couple at four corners of the vehicle.

13. A vehicle comprising an automotive imaging security system, the automotive imaging security system comprises:
four cameras coupled at four corners of the vehicle for capturing an immediate environment of the vehicle;
one or more sensors installed in the vehicle and configured to detect an occurrence of a predetermined event; and
a control unit operably coupled to the four cameras and the one or more sensors, the control unit configured to:
receive a signal from the one or more sensors indicating the occurrence of the predetermined event,
upon receiving the signal, activate the four cameras,
upon activation of the camera, receiving a video feed from the four cameras, and
transmitting, the video feed to an external device through a network,
wherein the control unit includes a network circuitry for connecting the network.

14. The vehicle according to claim 13, wherein the four cameras are installed just under a roof of the vehicle at a front right, front left, rear right, and read left sides of the vehicle.

15. The vehicle according to claim 13, wherein the immediate environment is a space surrounding the vehicle within predefined distance.

16. The automotive imaging security system according to claim 15, wherein the control unit is also configured to:
upon activation of the camera, focusing at least one camera of the four cameras on an object in the immediate environment.

17. The vehicle according to claim 16, wherein the predetermined event is the presence of a key fob within a predefined distance from the vehicle but outside the vehicle, the key fob including the keys of the vehicles, wherein the object is a face of a person carrying the key fob.

18. The vehicle according to claim 16, wherein the predetermined event is hitting the vehicle by another vehicle, wherein the object is a number plate of the another vehicle or a driver of the another vehicle.

19. The vehicle according to claim 16, wherein the predetermined event is an external impact on the vehicle.

20. A method of recording an immediate environment of a vehicle upon an occurrence of a predetermined event, the method comprising the steps of:
providing an automotive imaging security system comprising:
four cameras coupled at four corners of the vehicle for capturing an immediate environment of the vehicle,
one or more sensors installed in the vehicle and configured to detect an occurrence of a predetermined event,
a control unit operably coupled to the four cameras and the one or more sensors, the control unit configured to:
receive a signal from the one or more sensors indicating the occurrence of the predetermined event, and
upon receiving the signal, activate the four cameras;
detecting, by the one or more sensors, the presence of a key fob within the immediate environment and outside the vehicle, the key fob include the key of the vehicle; and
upon detecting the key fob, activating the four cameras.
